(19) United States
(12) Patent Application Publication
(10) Pub. No.: US 2016/0127412 A1
(43) Pub. Date: May 5, 2016

(54) METHOD AND SYSTEM FOR DETECTING EXECUTION OF A MALICIOUS CODE IN A WEB BASED OPERATING SYSTEM

(71) Applicant: SAMSUNG ELECTRONICS CO., LTD., Gyeonggi-do (KR)

(72) Inventors: Evgeny BESKROVNY, Ramat Gan (IL); Yaacov HOCH, Ramat Gan (IL)

(73) Assignee: SAMSUNG ELECTRONICS CO., LTD.

(21) Appl. No.: 14/533,194

(22) Filed: Nov. 5, 2014

(51) Int. Cl. H04L 29/06; H04L 29/08

(52) U.S. Cl. CPC H04L 63/1466; H04L 67/02

(57) ABSTRACT

A method for detecting a malicious code injected into the command stream of a widget running by a web-based OS at a device. The method is multi-stepped. Introducing by an App-Store hooks to within the command stream of the widget. Running at the App-Store the widget on an App-Store device, measuring respective time durations between various hooks, and recording said time durations within a metadata file. Associating said metadata file with said widget, and supplying said widget, and associated metadata file to within a user device. Upon running said widget by a web based OS at said user device, activating a monitoring module, determining durations between said introduced hooks, and comparing respectively said determined time durations with said measured time durations. And issuing an alert upon detection of a variation above a predefined value between any of said determined durations and said measured durations respectively.

### FIELD OF THE INVENTION

The invention relates to the field of detecting exploitation of a system by the execution of malicious code. More specifically, the invention relates to a method and system for detecting the running of a malicious code which is injected to within in the execution context of a widget at a device having a web based operating system.

### BACKGROUND OF THE INVENTION

The web based operating system is an emerging technology which becomes more and more popular these days. A prominent example is the Tizen OS developed jointly by Samsung Electronics and Intel Corporation, targeting consumer devices such as smartphones and SmartTVs.

A Web based operating system forms an execution environment, which is built around a web browser. This technology allows running within the device of widgets mainly written in HTML/JavaScript, said widgets are rendered by the runtime engine of the web browser.

The widget is the most typical software code for running within the Web based operating system. As the Web based OS is typically designed for the operation of mobile devices (such as smartphones, tablet, etc.) and smartTVs, the various widgets are typically supplied to the within the relevant device from an App-Store, which is most commonly owned by the manufacturer of the specific device. For example, widgets for the Samsung SmartTV are supplied by the Samsung owned App-Store.

As with any new platform, web based operating systems have their own unique set of security problems and weaknesses, many of which are inherent to the web OS architecture. The most prominent security weaknesses evolve from the lack of: (a) proper access control; (b) distinct and enforceable user privileges; and (c) a clear separation between the presentation layer and the business logic.

Injection-type vulnerabilities, such as, XSS and HTML injections are the most critical vulnerabilities that affect web based applications. These vulnerabilities allow execution of malicious code in the execution context of the vulnerable application (i.e., widget). The abovementioned type of security weakness amplifies the severity of malicious injection to any widget, an injection that may potentially result in a broad system exploit and a complete security compromise within the consumer device.

It is therefore an object of the present invention to provide a method and system for detecting and preventing the exploitation of injection-type vulnerabilities in a Web based Operating system environment.

It is another object of the present invention to provide a method and system for detecting and preventing such exploitation in a generic manner, with no requirement for a-priori knowledge of the malicious code nature, behavior, or its structure.

It is still another object of the present invention to provide such method and system in a simple and compact manner.

Other advantages of the present invention will become apparent as the description proceeds.

### SUMMARY OF THE INVENTION

The invention relates to a method for detecting a malicious code which is injected into the command stream of a widget running by a web-based OS at a device, which comprises: (a) introducing by an App-Store hooks to within the command stream of the widget; (b) running at the App-Store the widget on an App-Store device, measuring respective time durations between various hooks, and recording said time durations within a metadata file; (c) associating said metadata file with said widget, and supplying said widget, including said associated metadata file to within a user device which is substantially identical to said App-Store device; (d) upon running said widget by a web based OS at said user device, activating a monitoring module, determining by said module times durations between said introduced hooks, and comparing respectively said determined time durations with said measured time durations; and (e) issuing an alert upon detection of a variation above a predefined value between any of said determined durations and said measured durations respectively.

Preferably, said monitoring module is a part of said web-based OS.

Preferably, when an update is introduced at the APP-Store into said widget, a corresponding updated metadata file is also prepared, and sent to the device together with said update to the widget.

Preferably, when an update is introduced at the APP-Store introduced into said web based OS that affect any of said measured time durations, said metadata file is also updated respectively, and said updated metadata file is sent to the device together with said updated web based OS.

Preferably, said variation is a time value.

Preferably, said variation is a percentage value.

Preferably, the method is performed separately for each device model.

Preferably, all updates to said widget, said metadata file, and said web based OS are performed by the App-Store. Preferably, the hooks are introduced every X lines of the widget code, where X is a constant integer.

Preferably, the hooks are introduced only in functions that do not involve with inputting from a user.

Preferably, the hooks are introduced randomly within the widget lines of code.

### BRIEF DESCRIPTION OF THE DRAWINGS

In the drawings:

FIG. 1 shows a typical prior art system for running a widget within a device;

FIG. 2 shows a typical code streaming of a widget 12 within a device;

FIG. 3 illustrates how according to the present invention a device can detect an exploit of the execution of widget by means of injecting a malicious code into the widget execution context;

FIG. 4 describes a procedure according to the invention which is performed at the App-Store; and

FIG. 5 illustrates a procedure according to the invention which is performed within the device.

### DETAILED DESCRIPTION OF PREFERRED EMBODIMENTS

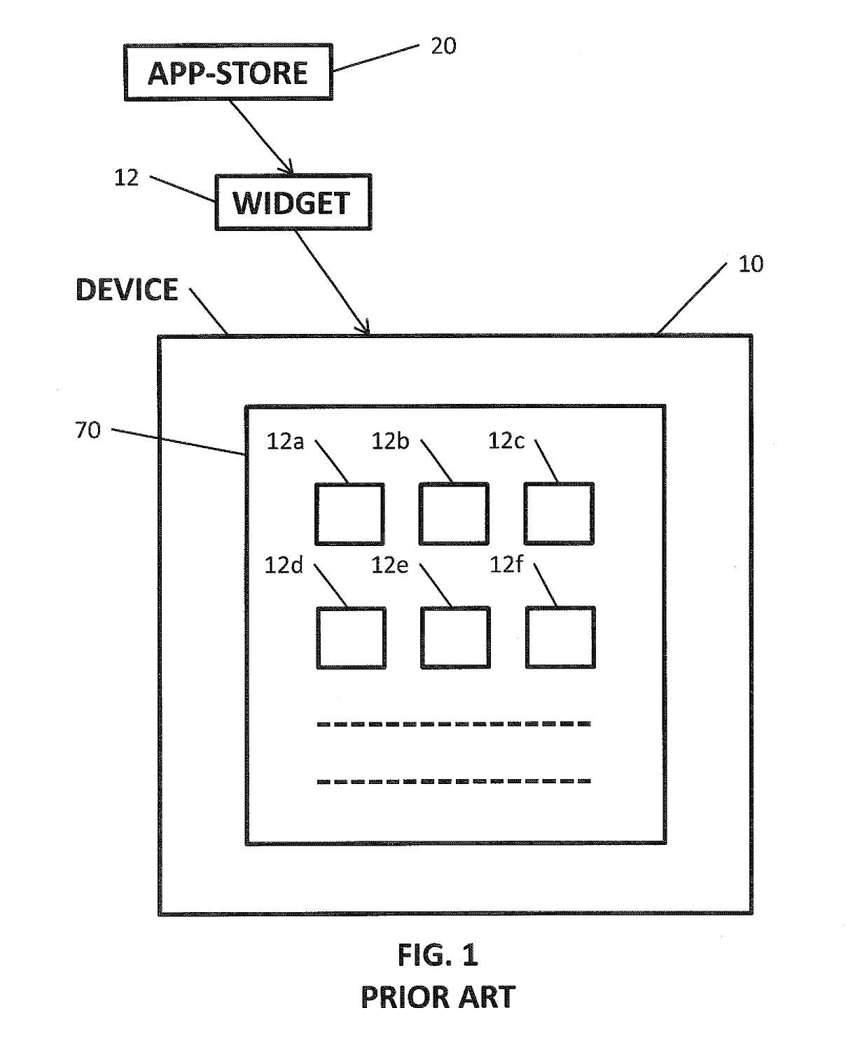

A typical prior art system for running a widget within a device is shown in FIG. 1. As noted above, a web based OS 70 is a browser-like operating system for use in mobile devices, SmartTVs, and the like devices. When used as the operating system of the device 10, it becomes the sole mechanism for initiating the running of widgets 12a-12f within the device. Moreover, the web based operating system 70 is generally supplied by the manufacturer of the device, which is the sole source for applying updates and revisions to the operating system—all those come from an entity 20 which is typically referred to in the art as the “App-Store”. The term App-Store was originally associated with a digital distribution platform for mobile applications on iOS, developed and maintained by Apple Inc. Later on, when many other manufacturers and distributors of mobile devices have adopted this type of platform, the meaning of the term was expanded such that it now refers to an application (or widget) distribution and update platform, which is maintained by any entity, typically by the manufacturer of the respective device 10. The present application refers to the term App-Store in said expanded meaning.

In any case, by its nature the App-store 20, even though receiving applications and widgets for distribution from many sources, is considered as a reliable entity whose task, among others, is to assure the authenticity, reliability, and security of the applications and widgets that are supplied to the end devices 10. Furthermore, to a large extent, each user of a device uses a single App-Store 20, which is typically owned and operated by the manufacturer of the respective device 10. As also noted, the App-Store 10 of the device manufacturer is also the supplier of the web based OS 70, when used to operate the device. These facts are utilized by the security system of the present invention.

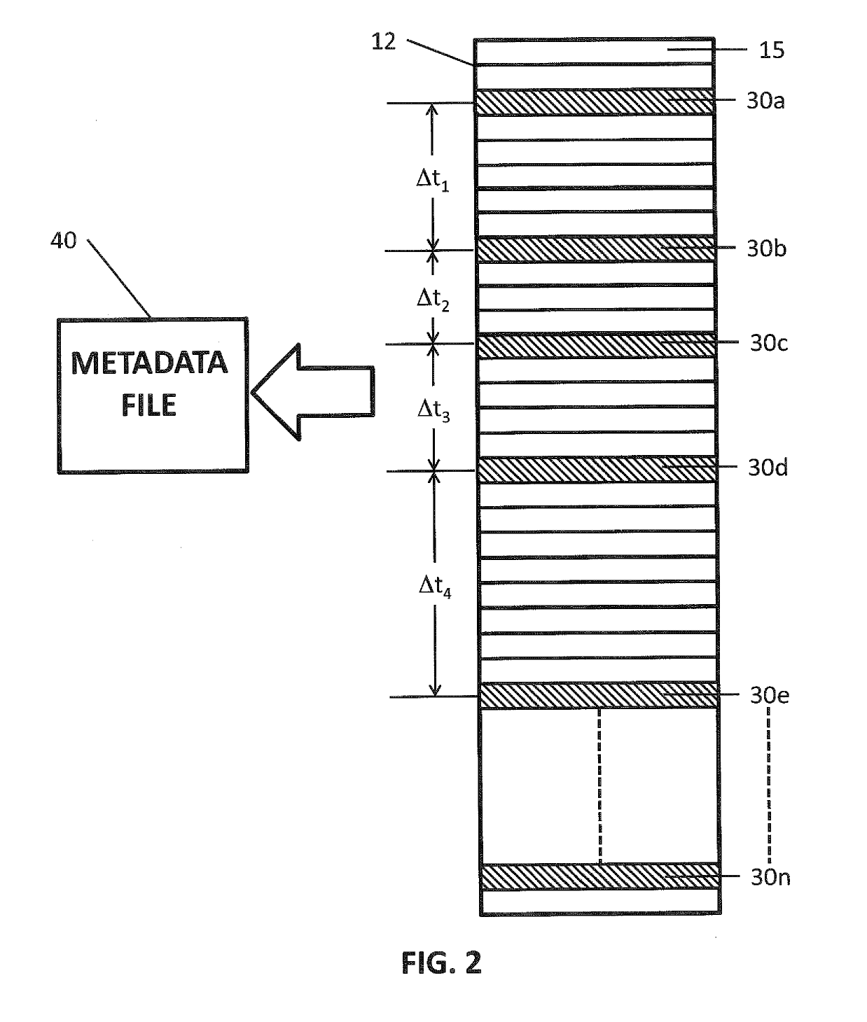

FIG. 2 shows a typical code streaming of a widget 12 within a device. As is well known, the code comprises plurality of commands 15, that are executed mostly one after the other, while also leaving to branches (sab-routines, etc.) from time to time. The inventors observed that while running by a web based OS on a device of a specific model, there are commands within the widget execution context for which the duration between their respective executions is substantially constant. For example, when running on a specific device, the duration Δt₁ has a specific duration value which may change from time to time by, for example ±10%. The other Δt values may also have a similar variation level. The variation level may depend on some other circumstances, such as on other widgets (or processes) that run simultaneously on the device, but typically the effects of these other simultaneously running widgets or processes on the specific times Δt respectively are relatively minor. These minor variations in the values of Δt evolve substantially from the type of tasks that are typically performed within the devices 10 that are operated by a web based OS.

On the other hand, it has been found that when a malicious code is injected to within the code context 12, the values of said Δts are very substantially affected, and may enlarge, for example, by 100% or more. This is because at least some of the most dangerous malicious codes use slow operating resources (such as a network), or involve in transfer of relatively large amounts of data. The present invention utilizes said latter observations as well.

According to the present invention, several “hooks” 30a-30n are spread within the code of each widget 12. The widget is then run by a web based OS within a specific device 10, and the time durations Δts between respective command executions are determined. This procedure of selecting the hooks locations and determination of the times Δt is typically performed by the APP-Store (or a similar reliable entity). The respective times durations Δts are then recorded within a meta-data file 40, which is associated with said specific widget 12 and said specific device 10.

There are various manners for selecting the locations of the hooks. In one embodiment, the hooks are placed once every X lines of code (where X is a constant integer). In another embodiment, the hooks are positioned at predefined functions, for example, at each function that does not involve inputting from the user. In still another embodiment, the hooks may be distributed randomly within the widget code lines. Various other considerations may be applied for selecting where to introduce the hooks.

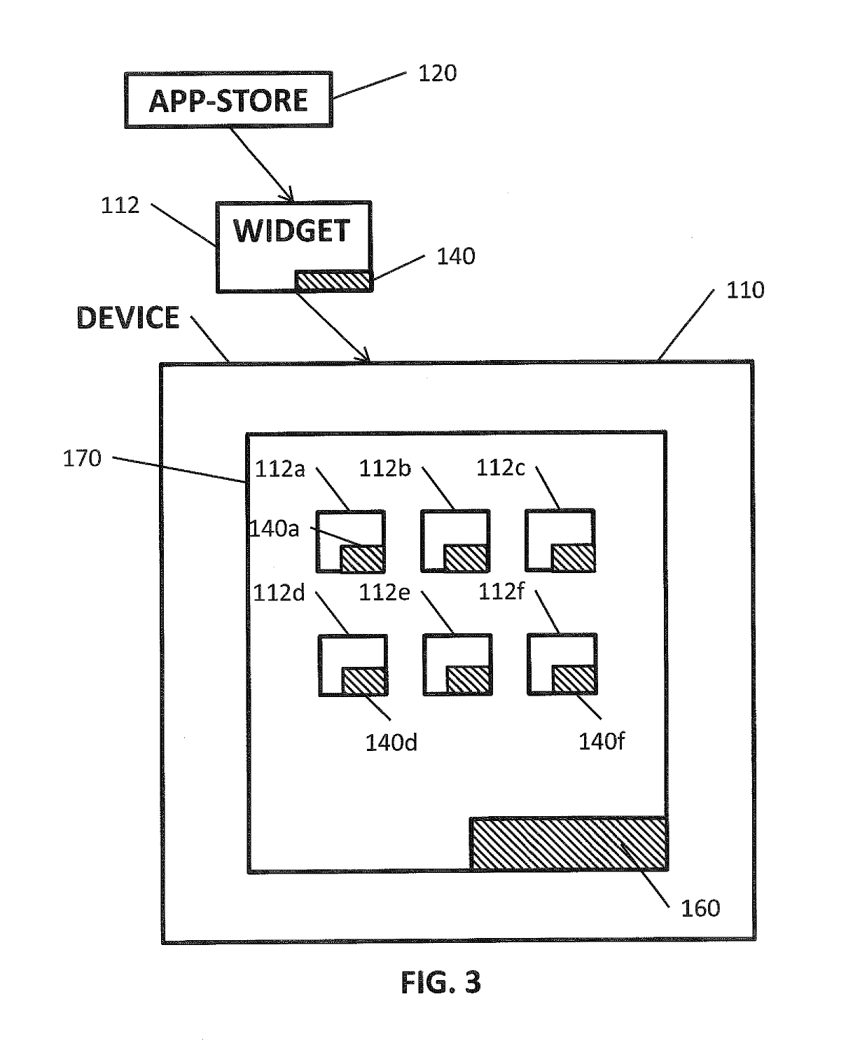

FIG. 3 illustrates how according to the present invention a device 110 can detect exploit of the execution of widget 112 by means of injecting a malicious code into the widget execution context. According to the present invention, the widget 112 which is conveyed to the device 110 (for example, from the App-Store 120 or from the manufacturer of the device 110) is associated with a respective meta data file 140, which comprises the values of said previously determined Δts. The web based OS 170 which is supplied to the device 110 from the App-Store 120 (or from the manufacturer of the device) is also modified to include a monitoring module 160. During real time operation, when the web based OS runs a specific widget 112 within the device 110, the monitoring module 160 monitors (i.e., measures) the times durations Δts, and compares them with the expected respective time durations Δts as included within the widget's respective metadata file 140. When the measured Δts are found to be within a specific predefined variation value Δx, the widget is considered to be clean from malicious code and reliable. However, when a variation above said predefined variation value Δx is determined, the widget is suspected to include a malicious code, and an alert is issued. Following this alert, any suitable action well known in the art may be taken. The values Δx may be indicated by either time variation or percentage from the expected value Δt. Moreover, and in order to increase accuracy, preferably another metadata file is produced for each specific device model and widget, to take into account variations in execution speeds by various devices.

As shown, the invention provides a mechanism for determining a malicious code which may be injected to within a widget execution context. This injection may come from any unreliable source, for example, a hacker. As shown, the invention utilizes the fact that typically all the widgets are conveyed to within a device from a reliable App-Store, which is typically owned by the same entity as the provider or manufacturer of the respective device. The security mechanism of the invention is substantially independent from the specific content or nature of the malicious code, so it can even detect a new and unfamiliar malicious code.

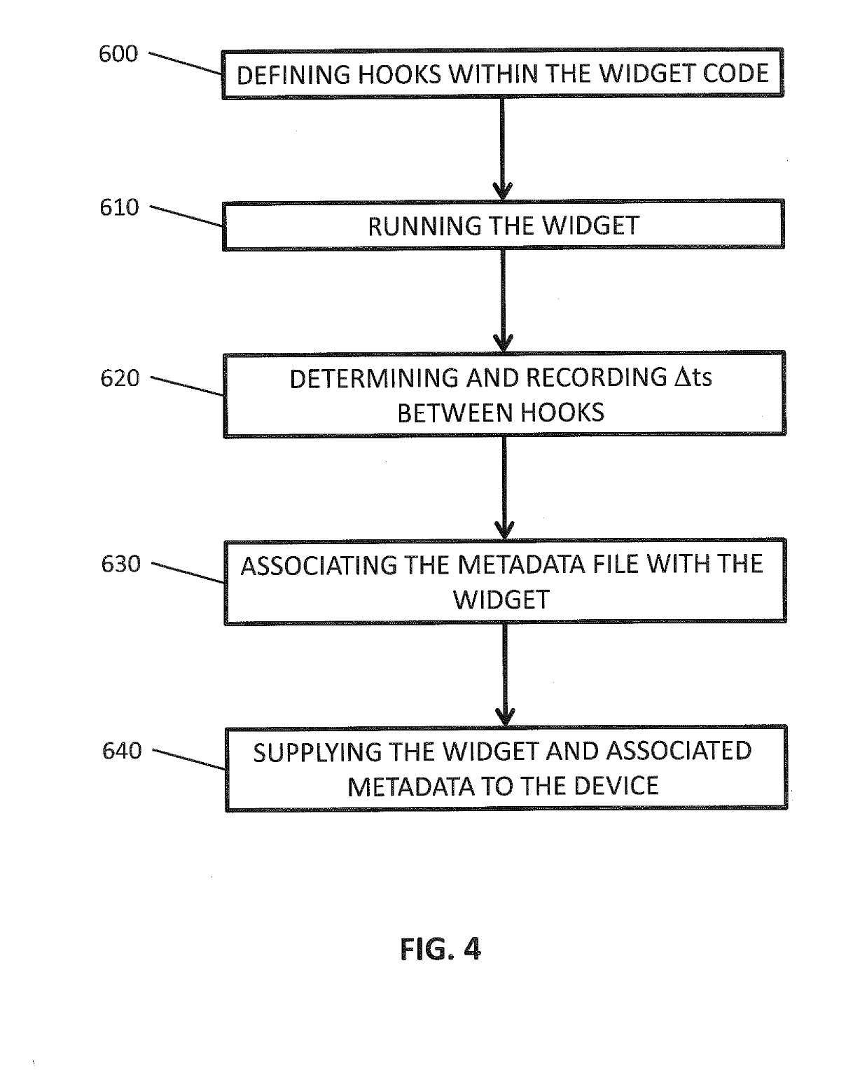

FIG. 4 describes the procedure which is performed at the App-Store. In the first step 600, hooks are predefined and introduced to within the widget code. In step 610, the App-Store runs the widget (including the hooks) on a specific device, by means of a web based operating system. In step 620, the times Δts between respective hooks are determined, and recorded within a respective metadata file. In step 630, the metadata file is associated with the respective widget, and in step 640 the widget and its associated metadata file are supplied to within the respective device. Although not shown in FIG. 4, the App-Store or the manufacturer of the device also provides a modified web based OS to the device which also includes the monitoring module 160 (shown in FIG. 3—the term “modified” indicates herein that the web based operating system at the device is in fact different from the standard OS by the inclusion of said monitoring module 160). From time to time, when updates are sent from the App-Store to a widget 112 or to the web based OS 70, corresponding updates may also be performed to one or more of said metadata file 140, or the monitoring module 160.

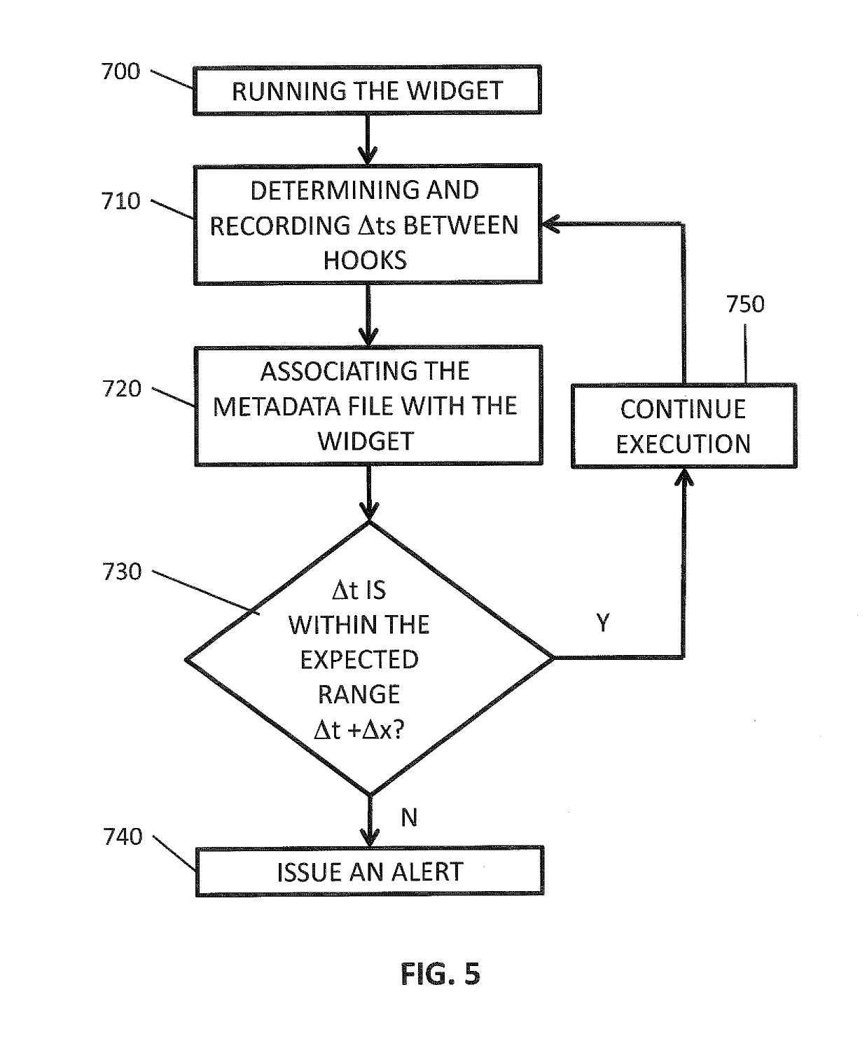

FIG. 5 illustrates the procedure which is performed within the device 10. In step 700, the web based OS executes the widget. In step 710, the monitoring module 160 of the OS determines a Δt between two hooks. In step 720, the determined At is compared respectively with the expected At, as listed within the metadata file 140. If the result of said comparison shows in step 730 that the value of the determined Δt is within the expected range in the meta data file (i.e., within the respective Δt±Δx in the metadata file), the execution of the widget continues in step 750, and a similar verification is made with respect to additional hooks (steps 710 to 730, respectively). If, however, it is found that the determined Δt value is beyond the expected value (i.e., beyond the respective Δt±Δx at the metadata file), an alert is issued in step 740.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for detecting a malicious code which is injected into the command stream of a widget running by a web-based OS at a device, which comprises:
a) introducing by an App-Store hooks to within the command stream of the widget;
b) running at the App-Store the widget on an App-Store device, measuring respective time durations between various hooks, and recording said time durations within a metadata file;
c) associating said metadata file with said widget, and supplying said widget, including said associated metadata file to within a user device which is substantially identical to said App-Store device;
d) upon running said widget by a web based OS at said user device, activating a monitoring module, determining by said module times durations between said introduced hooks, and comparing respectively said determined time durations with said measured time durations; and
e) issuing an alert upon detection of a variation above a predefined value between any of said determined durations and said measured durations respectively.

2. The method according to claim 1, wherein said monitoring module is a part of said web-based OS.

3. The method according to claim 1, wherein when an update is introduced at the APP-Store to said widget, a corresponding updated metadata file is also prepared, and sent to the device together with said update to the widget.

4. The method according to claim 1, wherein when an update is introduced at the APP-Store into said web based OS that affect any of said measured time durations, said metadata file is also updated respectively, and said updated metadata file is sent to the device together with said updated web based OS.

5. The method according to claim 1, wherein said variation is a time value.

6. The method according to claim 1, wherein said variation is a percentage value.

7. The method according to claim 1, which is performed separately for each device model.

8. The method according to claim 1, wherein all updates to said widget, said metadata file, and said web based OS are performed by the App-Store.

9. System according to claim 1, wherein the hooks are introduced every X lines of the widget code, where X is a constant integer.

10. System according to claim 1, wherein the hooks are introduced only in functions that do not involve with inputting from a user.

11. System according to claim 1, wherein the hooks are introduced randomly within the widget lines of code.
